(19) United States
(12) Patent Application Publication
(10) Pub. No.: US 2012/0007910 A1
(43) Pub. Date: Jan. 12, 2012

(54) Apparatus for inspecting inkjet head

(75) Inventor: Hyun Seok Lee, Seoul (KR)

(73) Assignee: SAMSUNG ELECTRO-MECHANICS CO., LTD., Suwon (KR)

(21) Appl. No.: 12/926,319

(22) Filed: Nov. 9, 2010

(30) Foreign Application Priority Data
Jul. 8, 2010 (KR) 10-2010-0065858

(51) Int. Cl. B41J 29/393

(52) U.S. Cl. 347/19

(57) ABSTRACT

Disclosed herein is an apparatus for inspecting an inkjet head. The apparatus for inspecting an inkjet head includes a scan unit that is connected to the piezoelectric actuator of an inkjet head to measure whether the capacitance of the piezoelectric actuator is changed; a pulse input unit that applies high voltage pulses to the scan unit; a switching unit that connects or disconnects the scan unit to or from the piezoelectric actuator and the pulse input unit; and a controller that controls the switching unit to connect the scan unit to the piezoelectric actuator and the pulse input unit and receives the information on whether the capacitance of the piezoelectric actuator is changed according to the applied high voltage pulse from the scan unit to determine whether the piezoelectric actuator is abnormal.

### CROSS REFERENCE TO RELATED APPLICATION

This application claims the benefit of Korean Patent Application No. 10-2010-0065858, filed on Jul. 8, 2010, entitled “Apparatus For Inspecting Inkjet Head”, which is hereby incorporated by reference in its entirety into this application.

### BACKGROUND OF THE INVENTION

1. Technical Field

The present invention relates to a technology capable of inspecting an operational state of a head, in a printer using an inkjet printing scheme.

2. Description of the Related Art

Recently, various technologies using a printing method to which an inkjet technology is applied have been introduced. A direct printing method using the inkjet technology forms patterns by the printing to remove a masking process, such that the process is simple and the manufacturing cost is saved.

In order to print ink to be applied to various applications in the inkjet technology, a piezoelectric type inkjet head is generally used. The inkjet head receives driving signals from a head driver to drive an actuator in a head, thereby printing ink. Therefore, the basic head driving operation is determined according to characteristics of a waveform of driving signals of the head driver. Generally, the driving signals are applied to the actuator in a pulse form.

In the inkjet technology, the reliability of the head is one of the most important parts. Generally, it has been known that the piezoelectric device in the head changes the capacitance value therein according to the used time. The change in capacitance of the piezoelectric device changes the ink discharging characteristics of the head. Therefore, a need exists for a technology capable of easily detecting the change in capacitance of the piezoelectric device.

### SUMMARY OF THE INVENTION

An object of the present invention is to provide a circuit for inspecting an inkjet head capable of easily detecting a change in capacitance of a piezoelectric actuator in an inkjet head using a simple circuit configuration.

According to an exemplary embodiment of the present invention, there is provided an apparatus for inspecting an inkjet head, including: a scan unit that is connected to the piezoelectric actuator of an inkjet head to measure whether the capacitance of the piezoelectric actuator is changed; a pulse input unit that applies high voltage pulses to the scan unit; a switching unit that connects or disconnects the scan unit to or from the piezoelectric actuator and the pulse input unit; and a controller that controls the switching unit to connect the scan unit to the piezoelectric actuator and the pulse input unit and receives the information on whether the capacitance of the piezoelectric actuator is changed according to the applied high voltage pulse from the scan unit to determine whether the piezoelectric actuator is abnormal.

The scan unit may include: an attenuator that converts the voltage of input high voltage pulse into a predetermined level; and a resistor of which one end is connected to an output end of the attenuator and the other end is connected to the piezoelectric actuator.

The scan unit may further include a diode of which one end is connected to the other end of the resistor and the other end is connected to a power supply unit Vcc of the inkjet head.

The scan unit may measure the change in voltage of the piezoelectric actuator over time according to the high voltage pulse to measure whether the capacitance of the piezoelectric actuator is changed.

The controller may compare the information on the change in voltage of the piezoelectric actuator transmitted from the scan unit over time with the pre-stored reference voltage for each time to determine whether the piezoelectric actuator is abnormal.

### BRIEF DESCRIPTION OF THE DRAWINGS

FIG. 1 is a block diagram showing the configuration of an apparatus 100 for inspecting an inkjet head according to one embodiment of the invention;

FIG. 2 is a circuit diagram showing in detail components of the apparatus 100 for inspecting an inkjet head according to one embodiment of the invention; and

FIG. 3 is a graph showing in a change in voltage of a connection unit 202 detected in a scan unit 104 according to an exemplary embodiment of the present invention over time.

### DESCRIPTION OF THE PREFERRED EMBODIMENTS

Hereinafter, exemplary embodiments of the present invention will be described with reference to the accompanying drawings. However, the invention may be embedded in many different forms and should not be construed as limited to the embodiments set forth herein.

In the following description, when it is determined that the detailed description of the conventional technology related to the present invention would confuse the gist of the present invention, such a description may be omitted. Terms used in the specification and claims herein are defined by considering the functions thereof in the present invention so that they may be varied according to a user's and an operator's intends or practices. Therefore, the definitions thereof should be construed based on the contents throughout the specification.

As a result, the spirit of the present invention is determined by the claims and the following exemplary embodiments may be provided to efficiently describe the spirit of the present invention to those skilled in the art.

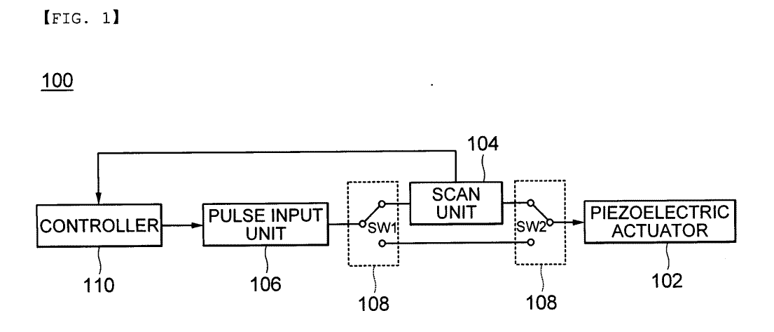

FIG. 1 is a block diagram showing the configuration of an apparatus 100 for inspecting an inkjet head according to one embodiment of the invention.

As shown in FIG. 1, an apparatus 100 for inspecting an inkjet head according to an exemplary embodiment of the present invention includes a piezoelectric actuator 102, a scan unit 104, a pulse input unit 106, a switching unit 108, and a controller 110.

The piezoelectric actuator 102 is a core component of an inkjet print head and discharges a droplet according to applied driving signals. The piezoelectric actuator 102 has electrical characteristics similar to a capacitor to detect the change in capacitance of the piezoelectric actuator 102, thereby making it possible to sense the change in characteristics of the piezoelectric actuator 102.

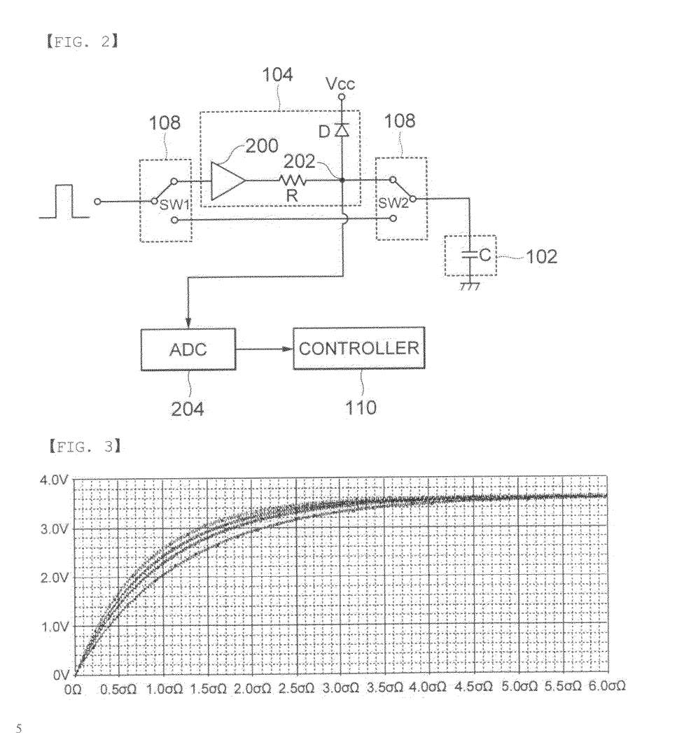

The scan unit 104 is connected to the piezoelectric actuator 102 to measure whether the capacitance of the piezoelectric actuator 102 is changed. The detailed configuration of the scan unit 104 will be described with reference to FIG. 2.

The pulse input unit 106 supplies a high voltage pulse to the piezoelectric actuator 102 or the scan unit 104. In other words, the high voltage pulse generated from the pulse input unit 106 is supplied to the piezoelectric actuator 102 as the head driving signals. In addition, when there is a need to determine whether or not the piezoelectric actuator 102 is abnormal, the high voltage pulse is input to the scan unit 104. In other words, in this case, the high voltage pulse functions as test signals to detect the change in capacitance of the piezoelectric actuator 102.

The switching unit 108 is configured to include two switches SW1 and SW2 and connects and disconnects the scan unit 104 to and from the pulse input unit 106 and the piezoelectric actuator 108, respectively. That is, In a general case, the switching unit 108 is directly supply the input of the pulse input unit 106 to the piezoelectric actuator 102 but when there is a need to determine whether the piezoelectric actuator 102 is abnormal, the switching unit 108 controls two switches SW1 and SW2 to connect the scan unit 104 between the pulse input unit 106 and the piezoelectric actuator 102.

The controller 110 controls the operation of each component configuring the apparatus 100 for inspecting an inkjet head. That is, the controller 110 controls the switching unit 108 to connect the scan unit 104 to the piezoelectric actuator 102 and the pulse input unit 106 and applies the high voltage pulse to the scan unit 104. In addition, the controller 110 receives the information on whether the capacitance of the piezoelectric actuator 102 is changed according to the high voltage pulse from the scan unit 104 to determine whether the piezoelectric actuator 102 is abnormal.

FIG. 2 is a circuit diagram showing in detail components of the apparatus 100 for inspecting an inkjet head according to one embodiment of the invention.

As shown, the scan unit 104 is positioned between the piezoelectric actuator 102 and the pulse input unit 106. When the head is generally driven, two switches SW1 and SW2 of the switching unit 108 are connected to the shown lower paths, respectively. Therefore, the high voltage pulse generated from the pulse input unit 106 is input the piezoelectric actuator 102. When there is a need to determine whether the capacitance of the piezoelectric actuator 102 is changed, the switches SW1 and SW2 are connected to the upper paths, respectively, and apply the high voltage pulse to the scan unit 104.

The scan unit 104 includes an attenuator 200, a resistor R, and a diode D. The attenuator 200 is a module to lower the voltage of the high voltage pulse to a proper level. One end of the resistor R is connected to an output end of the attenuator 200 and the other end thereof is connected to the piezoelectric actuator 102. As set forth above, the piezoelectric actuator 102 has the characteristics of the capacitor C and therefore, the resistor R and the piezoelectric actuator 102 configure the RC serial circuit as shown. One end of the diode D is connected to the other end of the resistor R and the other end thereof is connected to a power supply unit Vcc of the inkjet head. The above-mentioned diode D prevents the resistor R and the voltage of the connection unit 202 of the piezoelectric actuator 102 from being increased to a predetermined level or more. That is, the maximum voltage of the connection unit 202 becomes Vcc+the threshold voltage of the diode D by the diode D.

The operation of the apparatus 100 for inspecting an inkjet head configured as described above is as follows. First, when the two switches SW1 and SW2 are connected to the upper paths and when the high voltage pulse is applied from the pulse input unit 106, the high voltage pulse is changed to a proper level through the attenuator 200 and is applied to the RC serial circuit configured to include the resistor R and the piezoelectric actuator 102. Therefore, the voltage of the connection unit 202 is gradually increased over time. The change in voltage of the piezoelectric actuator 102 over time is applied to the controller 110 via an ADC 204 and the controller compares the information on the change in voltage of the piezoelectric actuator 102 transmitted from the scan unit 104 over time and the pre-stored reference voltage for each time, thereby determining whether the piezoelectric actuator is abnormal.

The voltage rising generated according to the pulse input is varied in the RC serial circuit according to the RC time constant. In the circuit shown, the resistance (R) value is fixed, such that the RC time constant is varied according to the capacitance of the piezoelectric actuator 102. Therefore, the controller 110 compares the information on the change in voltage of the piezoelectric actuator 102 transmitted from the scan unit 104 over time with the information (the information is pre-stored in the controller) on the change in voltage over time when the piezoelectric actuator 102 is normal, thereby making it possible to sense the change in capacitance of the piezoelectric actuator 102.

FIG. 3 is a graph showing in a change in voltage of a connection unit 202 detected in a scan unit 104 according to an exemplary embodiment of the present invention over time. As set forth above, it can be confirmed through FIG. 3 that there is a difference in the voltage value over time, according to the difference in the capacitance value.

According to the exemplary embodiment of the present invention, it can easily detect the change in capacitance of the piezoelectric actuator in the inkjet head through the simple circuit configuration in the head without using the separate special inspecting apparatus.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. An apparatus for inspecting an inkjet head, comprising:
a scan unit that is connected to the piezoelectric actuator of an inkjet head to measure whether the capacitance of the piezoelectric actuator is changed;
a pulse input unit that applies high voltage pulses to the scan unit;
a switching unit that connects or disconnects the scan unit to or from the piezoelectric actuator and the pulse input unit; and
a controller that controls the switching unit to connect the scan unit to the piezoelectric actuator and the pulse input unit and receives the information on whether the capacitance of the piezoelectric actuator is changed according to the applied high voltage pulse from the scan unit to determine whether the piezoelectric actuator is abnormal.

2. The apparatus for inspecting an inkjet head according to claim 1, wherein the scan unit includes:
an attenuator that converts the voltage of input high voltage pulse into a predetermined level; and
a resistor of which one end is connected to an output end of the attenuator and the other end is connected to the piezoelectric actuator.

3. The apparatus for inspecting an inkjet head according to claim 2, wherein the scan unit further includes a diode of which one end is connected to the other end of the resistor and the other end is connected to a power supply unit Vcc of the inkjet head.

4. The apparatus for inspecting an inkjet head according to claim 3, wherein the scan unit measures the change in voltage of the piezoelectric actuator over time according to the high voltage pulse to measure whether the capacitance of the piezoelectric actuator is changed.

5. The apparatus for inspecting an inkjet head according to claim 4, wherein the controller compares the information on the change in voltage of the piezoelectric actuator transmitted from the scan unit over time with the pre-stored reference voltage for each time to determine whether the piezoelectric actuator is abnormal.
